(19) United States
(12) Patent Application Publication
(10) Pub. No.: US 2014/0085261 A1
(43) Pub. Date: Mar. 27, 2014

(54) TOUCH PANEL AND TOUCH DISPLAY PANEL

(71) Applicants: Chun-Cheng Lu, Taichung City (TW); Hsiu-Lin Chan, Hsinchu County (TW); Kuo-Chang Su, Tainan City (TW); Chen-Hao Su, Taichung City (TW); Yu-Ting Chen, Taoyuan County (TW)

(72) Inventors: Chun-Cheng Lu, Taichung City (TW); Hsiu-Lin Chan, Hsinchu County (TW); Kuo-Chang Su, Tainan City (TW); Chen-Hao Su, Taichung City (TW); Yu-Ting Chen, Taoyuan County (TW)

(73) Assignees: WINTEK CORPORATION, Taichung City (TW); WINTEK (CHINA) TECHNOLOGY LTD., Guangdong Province (CN)

(21) Appl. No.: 14/038,752

(22) Filed: Sep. 27, 2013

(30) Foreign Application Priority Data
Sep. 27, 2012 (TW) 101135563

(51) Int. Cl. G06F 3/044

(52) U.S. Cl. CPC G06F 3/044
USPC 345/174

(57) ABSTRACT

A touch panel including a substrate, a decoration layer and a first touch unit is provided. The decoration layer is disposed on the substrate, wherein the decoration layer has a window, and the location of the decoration layer is defined as a peripheral region. The first touch unit is at least disposed within the window, and the first touch unit has a plurality of electrode pairs. The electrode pairs are disposed on the substrate. Each of the electrode pairs includes a driving electrode and a sensing electrode. The driving electrode and the sensing electrode are separated by a distance, and the distance is between 300 micrometers and 900 micrometers.

### CROSS-REFERENCE TO RELATED APPLICATION

This application claims the priority benefit of Taiwan application serial no. 101135563, filed on Sep. 27, 2012. The entirety of the above-mentioned patent application is hereby incorporated by reference herein and made a part of this specification.

### TECHNICAL FIELD

The invention relates to a touch panel, and more particularly, to a capacitive touch panel and a touch display panel, applied to a hovering operation.

### BACKGROUND

In order for the current electronic devices developing gradually to be user-friendly and good-functional, infrared sensors are usually mounted on the display panel, so that the user is capable of performing operations of the touch panel without touching the touch panel (namely, hovering) while approaching to it, such as unhygienic hands or unwanted to be overly close to the display panel etc. However, the additional infrared sensors will not only increase extra manufacturing cost, the sensible height thereof will also only be between 4 millimeters and 5 millimeters that is unable to satisfy the usage requirement nowadays, and the current capacitive touch panels are also unable to have the hovering effect effectively.

### SUMMARY

The invention is directed to a touch panel and a touch display panel, which have hovering effect in usage through a capacitive touch panel.

The invention provides a touch panel including a substrate, a decoration layer and a first touch unit. The decoration layer is disposed on the substrate, wherein the decoration layer has a window, and the location of the decoration layer is defined as a periphery region. The first touch unit is at least disposed within the window, and the first touch unit has a plurality of electrode pairs. The electrode pairs are disposed on the substrate. Each of the electrode pairs includes a driving electrode and a sensing electrode. The driving electrode and the sensing electrode are separated by a distance, and the distance is between 300 micrometers and 900 micrometers.

The invention further provides a touch panel including a substrate, a decoration layer, a first touch unit and at least one second touch unit. The decoration layer is disposed on the substrate, wherein the decoration layer has a window, and the location of the decoration layer is defined as a periphery region. The first touch unit is at least disposed within the window. The second touch unit has a plurality of electrode pairs, and the electrode pairs are disposed on the substrate. Each of the electrode pairs includes a driving electrode and a sensing electrode, wherein the driving electrode and the sensing electrode are separated by a distance, and the distance is between 300 micrometers and 900 micrometers.

The invention further provides a touch display panel including the aforementioned touch panel, a display panel and an optical adhesive. The display panel is disposed below the touch panel, and the optical adhesive is disposed between the display panel and the touch panel.

According to the foregoing, the touch panel in the invention may detect the approaching object without adding infrared sensors through the layout design of the relative locations between the driving electrode and the sensing electrode in the electrode pair, that is, a distance between the driving electrode and the sensing electrode, and the distance is between 300 micrometers and 900 micrometers.

In order to make the features and advantages of the present invention more comprehensible, the present invention is further described in detail in the following with reference to the embodiments and the accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic bottom view of a touch panel according to an embodiment of the invention.

FIG. 1B is a schematic three-dimensional view of a touch panel in FIG. 1A.

FIG. 1C is a schematic diagram of a touch display panel according to an embodiment of the invention.

FIG. 2A through FIG. 2E illustrate various top views of electrode pairs in the invention.

FIG. 3A through FIG. 3C illustrate various partial cross-sectional views of a touch panel in the invention.

FIG. 4 illustrates a curve diagram of a capacitance variation and a difference distance between a driving electrode and a sensing electrode.

FIG. 5 illustrates a curve diagram of a capacitance variation and a ratio of an area of a driving electrode and an area of a sensing electrode at the same distance.

### DESCRIPTION OF THE EMBODIMENTS

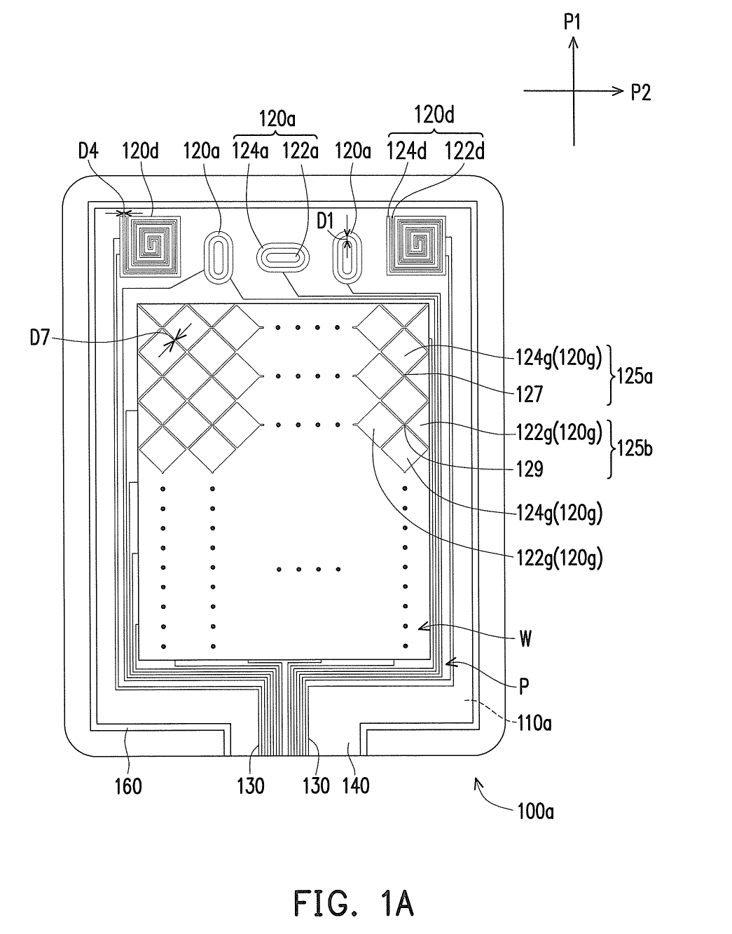

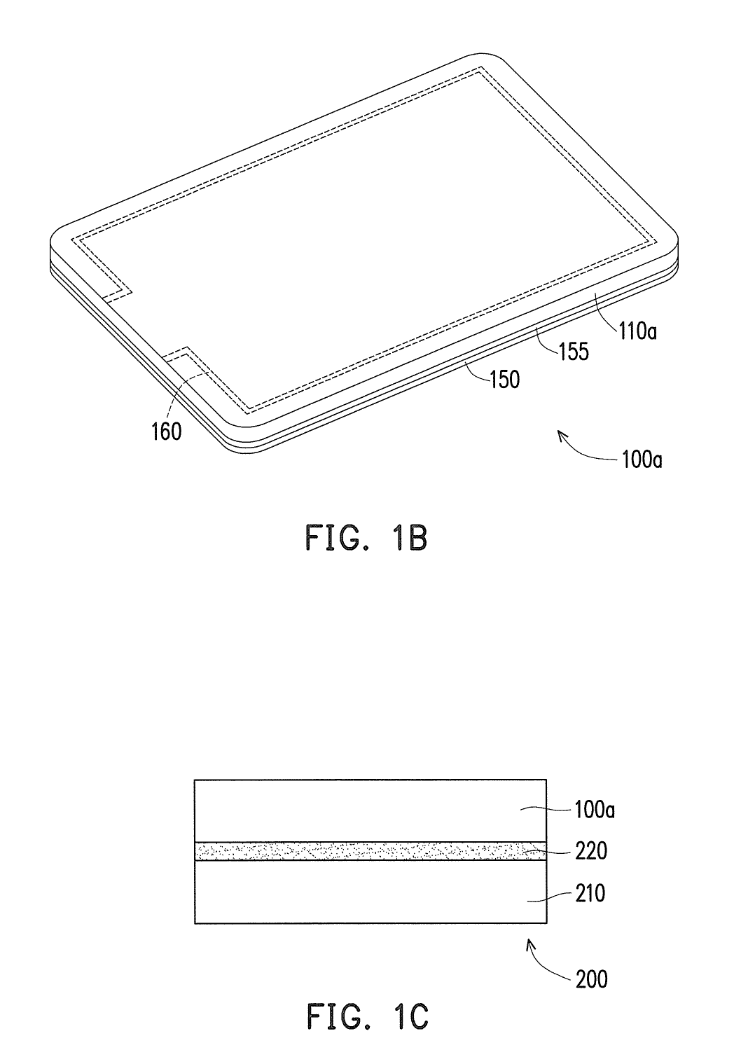

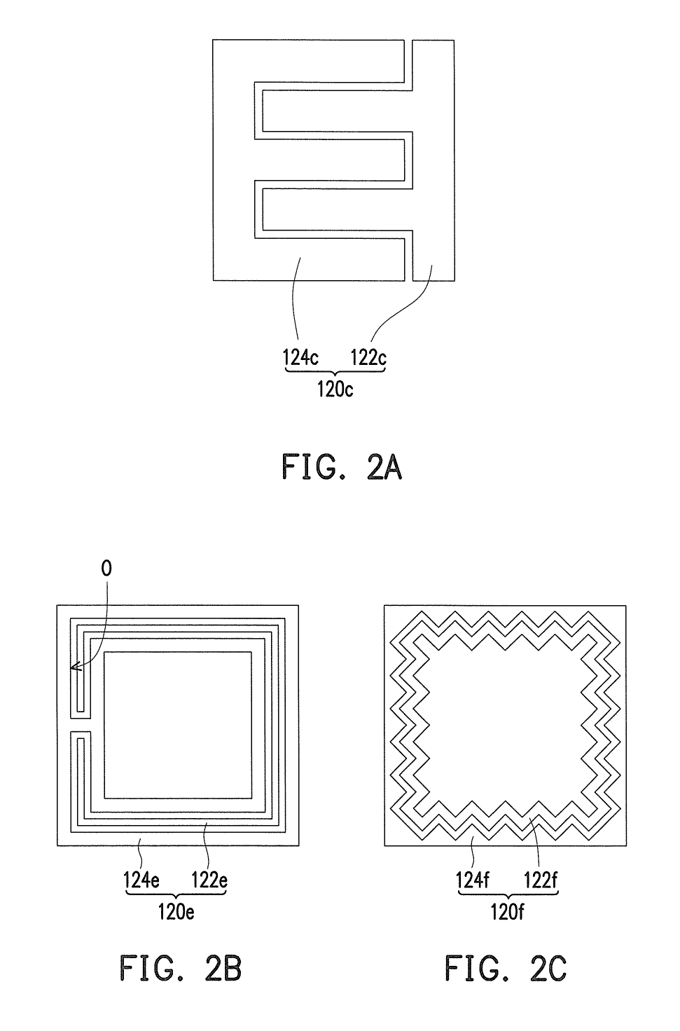

Referring to FIG. 1A, a touch panel 100a of the embodiment includes a substrate 110a, a first touch unit and at least one second touch unit, and the periphery of the substrate 110a is disposed with a decoration layer 140 thereon. The decoration layer 140 has a window W, and the location of the decoration layer 140 is defined as a periphery region P, wherein a first touch unit is at least disposed within the window W and may also extend to the periphery region P (wherein this part is not shown in the structural figure of some embodiment), and the first touch unit is disposed on the substrate 110a. The periphery region P is disposed with at least one second touch unit thereon, and the second touch unit is disposed in the periphery region P where the decoration layer 140 is located.

The substrate 110a may a substrate constituted by a soft material or a rigid material, such as a glass substrate, a rigid cover lens, a plastic substrate, a flexible cover lens, a flexible plastic substrate, for example, a plastic film, a thin glass substrate (as glass film) or a substrate of the display. Herein, at least one side of the above-mentioned cover lens has a decoration layer (not shown), for example, disposed on a portion of the peripheral area or the entire region of the peripheral area. The above-mentioned substrate of the display may include a color filter substrate of a liquid crystal display or a package cover of an organic light-emitting display. Further, the above-mentioned substrate of the display can only be one of the substrate and the opposite substrate. The material of the decoration layer 140 is, for instance, an ink, a photoresist material, a ceramic material or a diamond-like carbon material. The material of the first touch unit and the second touch unit is, for instance, an indium tin oxide (ITO), an indium zinc oxide (IZO), a metal mesh material, a nano-scale metal material or a metal material etc.

Referring to FIG. 1A again, in the embodiment, the first touch unit includes a plurality of electrode pairs 120g, and the second touch unit at least includes an electrode pair, for instance, the disposed electrode pairs 120a, 120d as shown in the figure. Herein, each of the electrode pairs 120a (or 120d, 120g) includes a driving electrode 122a (or 122d, 122g) and a sensing electrode 124a (or 124d, 124g) adjacent the driving electrode 122a (or 122d, 122g), wherein each of the driving electrodes 122a (or 122d, 122g) and each of the corresponding sensing electrodes 124a (or 124d, 124g) are separated by a distance D1 (or D4, D7), and the distance D1 (or D4, D7) is, for instance, between 300 micrometers and 900 micrometers.

More specifically, as shown in FIG. 1A, the driving electrode 122a of the electrode pair 120a may be a rod-like electrode and the sensing electrode 124a may be an enclosed-ring electrode, wherein the sensing electrode 124a surrounds the driving electrode 122a to form an elliptical-shape capacitor. The structural types of the driving electrode 122a and the sensing electrode 124a in the electrode pair 120a may also be replaced, but such means still belongs to an adoptable means in the invention and falls within the scope of the invention. For example, both the driving electrode 122d and the sensing electrode 124d of the electrode pair 120d may be the paper-clip shape electrodes, and the sensing electrode 124d surrounds the driving electrode 122d to form a rectangular capacitor. Furthermore, both the driving electrode 122g and the sensing electrode 124g of the electrode pair 120g may be the rhombus electrodes.

Preferably, the ratio of an area of the driving electrode 122a (or 122d, 122g) and an area of the sensing electrode 124a (or 124d, 124g) of each electrode pair 120a (or 120d, 120g) in the embodiment is, for instance, between 0.7 and 0.75. The distances D1, D4, D7 between the driving electrodes 122a, 122d, 122g and the corresponding sensing electrodes 124a, 124d, 124g are preferably between 600 micrometers and 900 micrometers, such that the touch sensitivity of the touch panel 100a may be enhance effectively.

Since the driving electrodes 122a, 122d, 122g and the corresponding sensing electrodes 124a, 124d, 124g are separated by the distances D1, D4, D7 in the embodiment, the distances D1, D4, D7 are between 300 micrometers and 900 micrometers, preferably, between 600 micrometers and 900 micrometers. Therefore, the range of electric field line distribution in the effective electric field may be increased, so that when the user (not shown) approaches to the touch panel 100a without touching (namely, hovering) that is, for instance, a vertical distance of 15 millimeters away from the touch panel 100a, the user may operate the touch panel 100a. Hence, the design of the touch panel 100a in the embodiment may be achieved without increasing the manufacturing cost and have greater touch sensitivity.

As shown in FIG. 1A, the first touch unit located within the window W has a plurality of electrode pairs 120g, and the touch panel 100a may further include a plurality of first connecting portions 127 and a plurality of second connecting portions 129. Each of the first connecting portions 127 is located between the two adjacent sensing electrodes 124a to define a plurality of sensing series 125a. Each of the second connecting portions 129 is located between the two adjacent driving electrodes 122a to define a plurality of driving series 125b. The plurality of driving series 125b and the plurality of sensing series 125a intersect with each other.

In addition, referring to FIG. 1 A and FIG. 1B simultaneously, in order to prevent or decrease the effect of electrostatic discharge to the touch panel 100a, the touch panel 100a of the embodiment may also further include an electrostatic protective ring 160, wherein the electrostatic protective ring 160 is disposed on edges of the decoration layer 140. When the touch panel 100a generates an electrostatic discharge current (not shown), the electrostatic discharge current may conduct to the electrostatic protective ring 160, so as to prevent the electrostatic discharge current damaging the components in the touch panel 100a.

Since the distance D7 between the driving electrode 122g and the sensing electrode 124g in each of the electrode pairs 120g located within the window W in the embodiment is less than the distance D1 (or D4) between the driving electrode 122a (or 122d) and the sensing electrode 124a (or 124d) in each of the electrode pairs 120a (or 120d) located within the periphery region P, the touch panel 100a may also have greater touch sensitivity and visual effect, other than the hovering effect on the touch panel 100a is achieved without increasing the manufacturing cost.

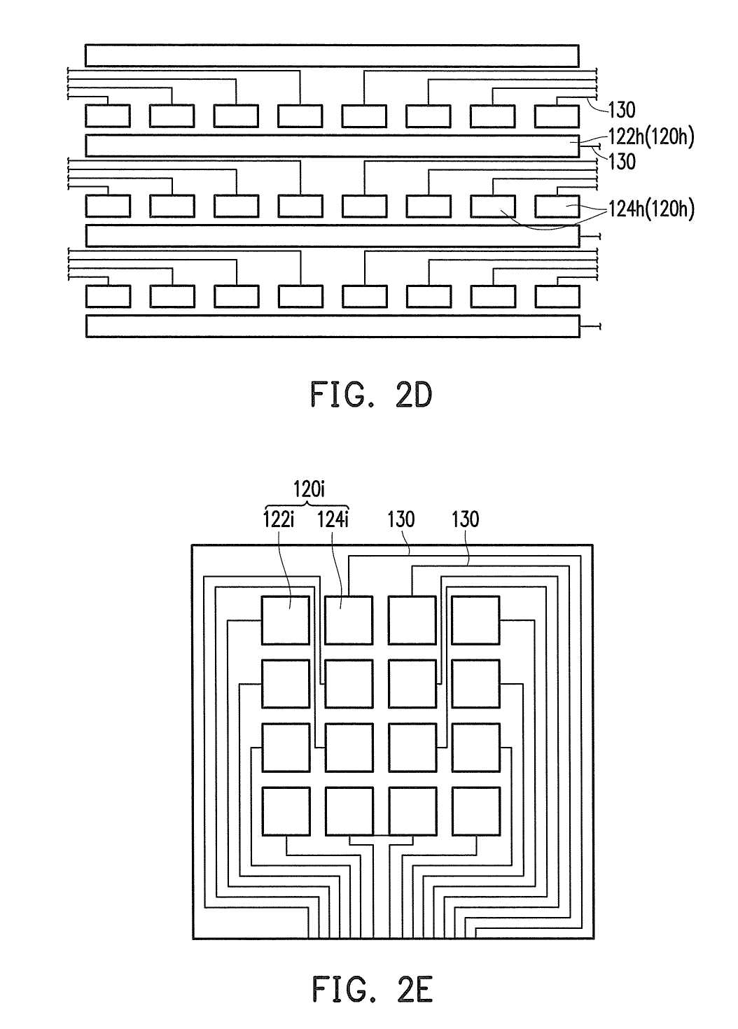

It should be noted that, the structural type of the electrode pairs in the embodiment is not limited thereto. Referring to FIG. 2A, both the driving electrode 122c and the sensing electrode 124c of the electrode pair 120c may also be the interdigitated-finger shape electrodes, and the driving electrode 122c and the sensing electrode 124c are coupled together to form a rectangular capacitor; referring to FIG. 2B, the driving electrode 122e of the electrode pair 120e may also be a unenclosed-ring electrode, and the sensing electrode 124e thereof may also be a enclosed-ring electrode, wherein the sensing electrode 124e has an enclosed groove O and the driving electrode 122e is located within the enclosed groove O, and the driving electrode 122e and the sensing electrode 124e form a rectangular capacitor; referring to FIG. 2C, the driving electrode 122f of the electrode pair 120f may also be a zigzag enclosed-ring electrode, and the sensing electrode 124f thereof may also be a rectangular annular electrode, wherein a side of the sensing electrode 124f corresponding to the driving electrode 122f may be in a zigzag manner, and the sensing electrode 124f surrounds the driving electrode 122f to form a rectangular capacitor. In brief, the structural type and the arrangement of the electrode pairs illustrated in each of the embodiments are exemplified to describe herein, but the invention is not limited thereto.

Certainly, the first touch unit of the embodiment is also not limited to the structural type of the electrode pairs 120g located within the window W of the substrate 110a. Referring to FIG. 2D, the driving electrode 122h of the electrode pair 120h may also be a strip electrode, and the sensing electrode 124h thereof may also be a rectangular electrode, wherein a plurality of sensing electrodes 124h is disposed beside each of the driving electrodes 122h, and the arrangement of the electrode pairs 120h define a single-layered touch structural layer. Alternatively, referring to FIG. 2E, both the driving electrode 122i and the sensing electrode 124i of the electrode pair 120i may also be the rectangular electrodes, and the arrangement of the electrode pairs 120i define a single-layered touch structural layer. The aforementioned means still belongs to an adoptable means in the invention and falls within the scope of the invention.

Referring to FIG. 1C, a touch display panel 200 of the embodiment includes the aforementioned touch panel 100a, a display panel 210 and an optical adhesive 220. The display panel 210 is disposed below the touch panel 100a. The optical adhesive 220 is disposed between the display panel 210 and the touch panel 100a. Moreover, referring to FIG. 1B simultaneously, when the touch panel 100a and the display panel 210 in the embodiment are combined together, the touch panel 100a of the embodiment may further include a transparent conductive layer 150 and an insulating layer 155 in order to prevent and decrease the effect of noises generated by the display panel 210 to the touch panel 100a, wherein the insulating layer 155 covers the substrate 110a, the decoration layer 140, the first touch unit and the second touch unit entirely, and the transparent conductive layer 150 covers the surface of the insulating layer 155, which may reduce noises effectively.

Herein, the display panel 210 is, for instance, a liquid crystal display panel, an organic light-emitting display panel, an electronic paper display panel, an electrophoretic display panel, an electro wetting display panel, a bistable display panel or a plasma display panel.

The following exemplary embodiments are provided to describe layer structure of the first touch unit of the touch panel, wherein the reference numerals and some contents of the aforementioned exemplary embodiments are also employed, and the same reference numerals are applied to denote the same or like elements in the following exemplary embodiments, and thus descriptions of the same technical contents are omitted. Moreover, the aforementioned exemplary embodiments may be referred for the omitted descriptions, so that the omitted parts are not further described in the following exemplary embodiments.

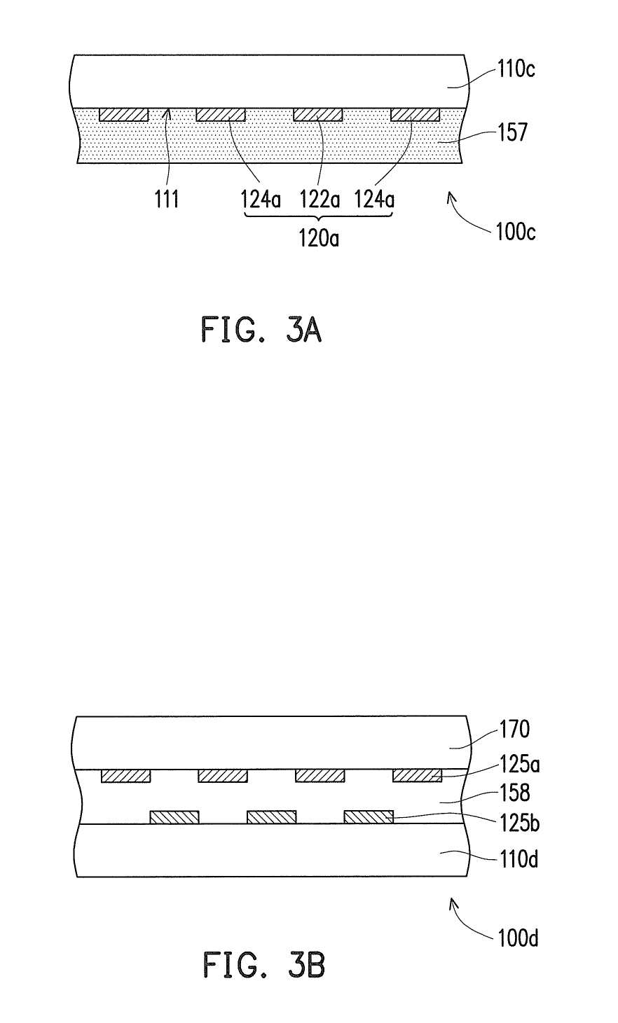

Firstly, referring to FIG. 3A, a touch panel 100c of the embodiment further includes an insulating layer 157, and the driving electrode 122a and the sensing electrode 124a of the electrode pair 120a of the touch panel 100c are all located on the substrate 110c, where the insulating layer 157 covers the substrate 110c, the driving electrode 122a and the sensing electrode 124a. Concurrently, referring to FIG. 1A, one or both of the first touch unit and the second touch unit may be selected to have the hovering effect, where the driving electrode 122a and the corresponding sensing electrode 124a are separated by a distance, and the distance is between 300 micrometers and 900 micrometers.

Referring to FIG. 3B, a touch panel 100d of the embodiment further includes an opposite substrate 110d and an insulating layer 158. The first touch unit may be respectively disposed on the substrate 170 and the opposite substrate 110d, for instance, the plurality of driving series 125b in FIG. 1A are disposed on the opposite substrate 110d, or the plurality of sensing series 125a in FIG. 1A are disposed on the substrate 170. Herein, the insulating layer 158 is located between the substrate 170 and the opposite substrate 110d, so as to separate and insulate the plurality of driving series 125b and the plurality of sensing series 125a. The first touch unit does not have the hovering effect, on the other hand, the second touch unit may have the aforementioned electrode pairs having the hovering effect, which are simultaneously disposed on a surface of the substrate 170 or the opposite substrate 110d, preferably, are simultaneously disposed on a surface of the substrate 170.

Herein, the opposite substrate 110d may a glass substrate, a plastic substrate, a flexible plastic substrate, for example, a plastic film, a thin glass substrate (as glass film) or a substrate of the display. The above-mentioned substrate of the display may include a color filter substrate of a liquid crystal display or a package cover of an organic light-emitting display. Further, the above-mentioned substrate of the display can only be one of the substrate and the opposite substrate.

Referring to FIG. 3C, a touch panel 100e of the embodiment further includes an opposite substrate 110e and an insulating layer 159. The first touch unit may be respectively disposed on the two surfaces of the opposite substrate 110e, for instance, the plurality of sensing series 125a in FIG. 1A are disposed on the surface (facing the substrate 175) of the opposite substrate 110e, and the plurality of driving series 125b in FIG. 1A are disposed on the surface (opposite the plurality of sensing series 125a) of the opposite substrate 110e, where the insulating layer 159 is located between the substrate 175 and the opposite substrate 110e. The first touch unit does not have the hovering effect, on the other hand, the second touch unit may have the aforementioned electrode pairs having the hovering effect, which are simultaneously disposed on a surface of the substrate 175 or the opposite substrate 110e, preferably, are simultaneously disposed on a surface (facing the substrate 175)of the opposite substrate 110e.

Herein, the opposite substrate 110e may a glass substrate, a plastic substrate, a flexible plastic substrate, for example, a plastic film, a thin glass substrate (as glass film) or a substrate of the display. The above-mentioned substrate of the display may include a color filter substrate of a liquid crystal display or a package cover of an organic light-emitting display. Further, the above-mentioned substrate of the display can only be one of the substrate and the opposite substrate.

The following exemplary examples are the simulations for various distances between the driving electrode and the sensing electrode and various ratios of the area of the driving electrode and the area of the sensing electrode, thereby obtaining the relationship between the aforementioned parameters and the capacitance variation.

TABLE 1

| | Form | | | | | | |
|---|---|---|---|---|---|---|---|
| | E1 | E2 | E3 | E4 | E5 | E6 | E7 |
| Distance (μm) | 300 | 500 | 700 | 900 | 1000 | 900 | 900 |
| Ratio | 1.164 | 1.148 | 0.771 | 0.754 | 0.746 | 0.631 | 0.876 |

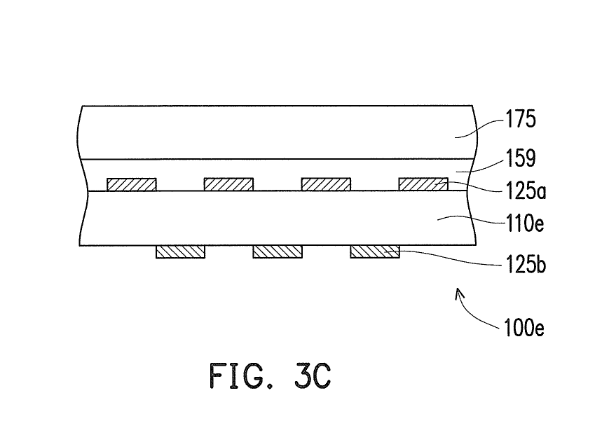

Referring to Table 1 and FIG. 4 simultaneously, from the curve in FIG. 4, it should be noticed that Form E4 has the maximum capacitance variation, which means when the distance between the driving electrode and the corresponding sensing electrode is 900 micrometers and the ratio of the area of the driving electrode and the area of the sensing electrode is 0.754, the highest capacitance variation may be obtained. In addition, from the curve in FIG. 4, it should also be noticed that when the distance between the driving electrode and the corresponding sensing electrode is between 300 micrometers and 900 micrometers but the ratio of the area of the driving electrode and the area of the sensing electrode is not between 0.7 and 0.75, the capacitance variation thereof is clearly not as much as the capacitance variation for the ratio of the area of the driving electrode and the area of the sensing electrode is between 0.7 and 0.75. In brief, the design for the electrode pairs of the touch panel in the aforementioned embodiments may obtain the optimal hovering touch effect.

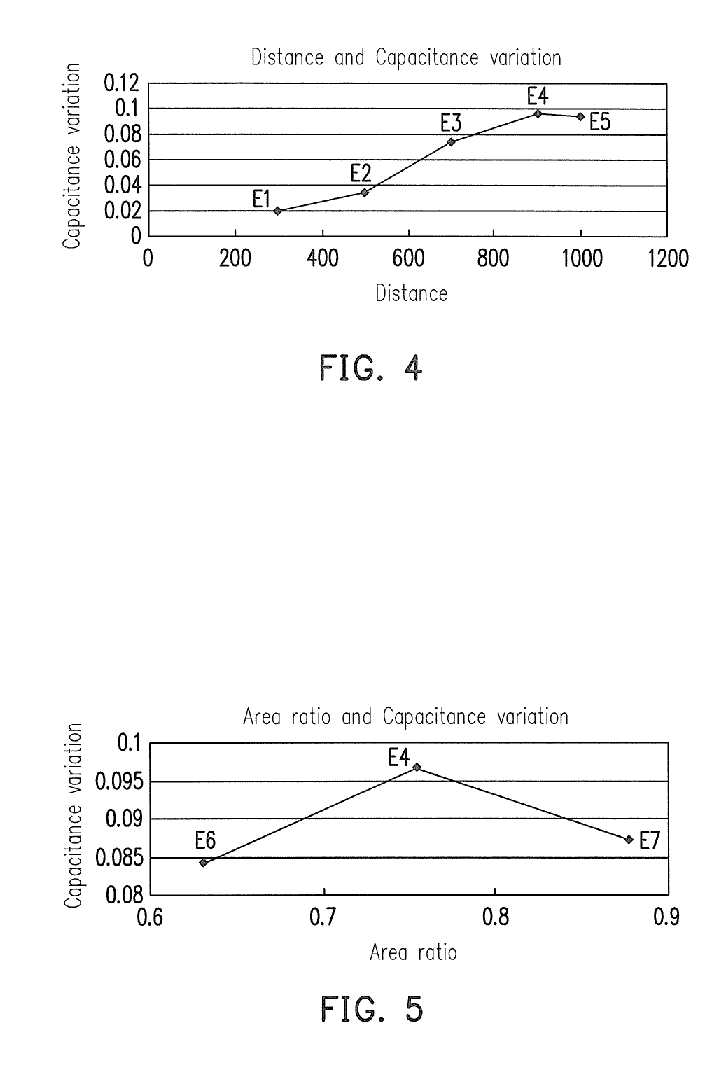

Referring to Table 1 and FIG. 5 simultaneously, from the curve in FIG. 5, it should be noticed that Form E4 has the maximum capacitance variation, which means when the distances between the driving electrode and the corresponding sensing electrode are 900 micrometers and the ratio of the area of the driving electrode and the area of the sensing electrode is 0.754, the highest capacitance variation may be obtained. In other words, under the circumstance that the distances between the driving electrode and the corresponding sensing electrode are identical and the ratio of the area of the driving electrode and the area of the sensing electrode is less/greater than 0.7 and 0.75, the capacitance variations thereof are not as much as the capacitance variation for the ratio of the area of the driving electrode and the area of the sensing electrode is between 0.7 and 0.75.

To sum up, the electrode pairs having the hovering effect in the invention may be disposed on the first touch unit or the second touch unit, and may also be disposed simultaneously on the first touch unit and the second touch unit, where the driving electrodes and the corresponding sensing electrodes, having the hovering effect, are separated by a distance, and the distance is between 300 micrometers and 900 micrometers. Accordingly, the range of electric field line distribution in the effective electric field may be increased, so that when the user (not shown) approaches to the touch panel without touching that is, for instance, a vertical distance of 15 millimeters away from the touch panel, the user may operate the touch panel.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch panel, comprising:
a substrate;
a decoration layer, disposed on the substrate, wherein the decoration layer has a window; and
a first touch unit, at least disposed within the window, wherein the first touch unit has a plurality of electrode pairs and the electrode pairs are disposed on the substrate, each of the electrode pairs comprises a driving electrode and a sensing electrode, the driving electrode and the sensing electrode are separated by a distance, and the distance is between 300 micrometers and 900 micrometers.

2. The touch panel as claimed in claim 1, wherein the location of the decoration layer is defined as a periphery region.

3. The touch panel as claimed in claim 1, wherein the distance is between 600 micrometers and 900 micrometers.

4. The touch panel as claimed in claim 1, further comprising a plurality of first connecting portions and a plurality of second connecting portions, each of the first connecting portions is located between the two adjacent driving electrodes so as to connect the driving electrodes in series through the first connecting portions along a first direction to define a plurality of first sensing series, and each of the second connecting portions is located between the two adjacent sensing electrodes so as to connect the sensing electrodes in series through the second connecting portions along a second direction to define a plurality of second sensing series, and the plurality of first sensing series and the plurality of second sensing series are insulated form each other.

5. The touch panel as claimed in claim 1, wherein the driving electrode and the sensing electrode in each of the electrode pairs are arranged in a rectangular arrangement, a paper-clip shape arrangement, an annular arrangement or a interdigitated-finger shape arrangement.

6. The touch panel as claimed in claim 1, further comprising an opposite substrate and an insulating layer, wherein the insulating layer is located between the substrate and the opposite substrate, and the insulating layer covers the electrode pairs.

7. The touch panel as claimed in claim 1, further comprising an electrostatic protective ring disposed on edges of the substrate and surrounded the electrode pairs.

8. A touch panel, comprising:
a substrate;
a decoration layer, disposed on the substrate, wherein the decoration layer has a window;
a first touch unit, at least disposed within the window; and
at least one second touch unit, disposed on the decoration layer, wherein the second touch unit has a plurality of electrode pairs and the electrode pairs are disposed on the substrate, each of the electrode pairs comprises a driving electrode and a sensing electrode, the driving electrode and the sensing electrode are separated by a distance, and the distance is between 300 micrometers and 900 micrometers.

9. The touch panel as claimed in claim 8, wherein the location of the decoration layer is defined as a periphery region.

10. The touch panel as claimed in claim 8, wherein a ratio of an area of the driving electrode and an area of the sensing electrode is between 0.7 and 0.75.

11. The touch panel as claimed in claim 8, wherein the distance is between 600 micrometers and 900 micrometers.

12. The touch panel as claimed in claim 8, wherein the first touch unit comprises a plurality of sensing electrodes and a plurality of driving electrodes, and the touch panel further comprises a plurality of first connecting portions and a plurality of second connecting portions, each of the first connecting portions is located between the two adjacent sensing electrodes so as to connect the sensing electrodes in series through the first connecting portions along a first direction to define a plurality of first sensing series, and each of the second connecting portions is located between the two adjacent driving electrodes so as to connect the driving electrodes in series through the second connecting portions along a second direction to define a plurality of second sensing series, and the plurality of first sensing series and the plurality of second sensing series are insulated form each other.

13. The touch panel as claimed in claim 8, wherein the driving electrode and the sensing electrode in each of the electrode pairs are arranged in a rectangular arrangement, a paper-clip shape arrangement, an annular arrangement or a interdigitated-finger shape arrangement.

14. The touch panel as claimed in claim 8, further comprising an opposite substrate and an insulating layer, wherein the insulating layer is located between the substrate and the opposite substrate, and the insulating layer covers the electrode pairs.

15. The touch panel as claimed in claim 8, further comprising an electrostatic protective ring disposed on edges of the substrate and surrounded the electrode pairs.

16. The touch panel as claimed in claim 8, wherein the first touch unit extends to the periphery region.

17. A touch display panel, comprising:
the touch panel as claimed in claim 1;
a display panel, disposed below the touch panel; and
an optical adhesive, disposed between the display panel and the touch panel.

18. A touch display panel, comprising:
the touch panel as claimed in claim 8;
a display panel, disposed below the touch panel; and
an optical adhesive, disposed between the display panel and the touch panel.
